(19) United States
(12) Patent Application Publication
(10) Pub. No.: US 2026/0073264 A1
(43) Pub. Date: Mar. 12, 2026

(54) QUANTUM CIRCUIT FOR SIMULATING A UNITARY VIBRATIONAL COUPLED CLUSTER AND METHODS FOR USE THEREWITH

(71) Applicant: BEIT Sp. z o.o., Kraków (PL)

(72) Inventors: Michal Marek Szczepanik, Knybawa (PL); Emil Zak, Krakow (PL)

(21) Appl. No.: 19/286,994

(22) Filed: Jul. 31, 2025

Related U.S. Application Data
(60) Provisional application No. 63/692,834, filed on Sep. 10, 2024.
(60) Provisional application No. 63/693,340, filed on Sep. 11, 2024.

(51) Int. Cl. G06N 10/20

(52) U.S. Cl. CPC G06N 10/20

(57) ABSTRACT

An n-qubit quantum circuit includes: a first unitary circuit operating on n qubits, where n is equal to 2 m; a rotation gate controlled by m of the n qubits; and a second unitary circuit operating on the n qubits; wherein n-qubit quantum circuit implements an m-excitation gate corresponding to a unitary vibrational coupled-cluster (UVCC).

### CROSS REFERENCE TO RELATED APPLICATIONS

The present U.S. Utility Patent Application claims priority pursuant to 35 U.S.C. § 119(e) to U.S. Provisional Application No. 63/692,834, entitled “QUANTUM CIRCUIT FOR SIMULATING A UNITARY VIBRATIONAL COUPLED CLUSTER AND METHODS FOR USE THEREWITH”, filed Sep. 10, 2024; and U.S. Provisional Application No. 63/693,340, entitled “QUANTUM CIRCUIT FOR SIMULATING A UNITARY VIBRATIONAL COUPLED CLUSTER AND METHODS FOR USE THEREWITH”, filed Sep. 11, 2024, both of which are hereby incorporated herein by reference in their entirety and made part of the present U.S. Utility Patent Application for all purposes.

### BACKGROUND OF THE INVENTION

### Technical Field of the Invention

This invention relates generally to computer systems and particularly to quantum computing techniques and circuits.

### Description of Related Art

Computing devices are known to communicate data, process data, and/or store data. Such computing devices range from wireless smart phones, laptops, tablets, personal computers (PC), work stations, smart watches, connected cars, and video game devices, to web servers and data centers that support millions of web searches, web applications, or on-line purchases every day. In general, a computing device includes a processor, a memory system, user input/output interfaces, peripheral device interfaces, and an interconnecting bus structure.

Classical digital computing devices operate based on data encoded into binary digits (bits), each of which has one of the two definite binary states (i.e., 0 or 1). In contrast, a quantum computer utilizes quantum-mechanical phenomena to encode data as quantum bits or qubits, which can be in superpositions of the traditional binary states.

### BRIEF DESCRIPTION OF THE SEVERAL VIEWS OF THE DRAWING(S)

FIG. 1A is a block diagram of an example of a quantum computing architecture;

FIG. 1B is a block diagram of an example of a unitary circuit;

FIG. 1C is a flow diagram of an embodiment of a method;

FIG. 2A is a block diagram of an example of a quantum circuit; and

FIG. 2B is a block diagram of an example of a quantum circuit.

### DETAILED DESCRIPTION OF THE INVENTION

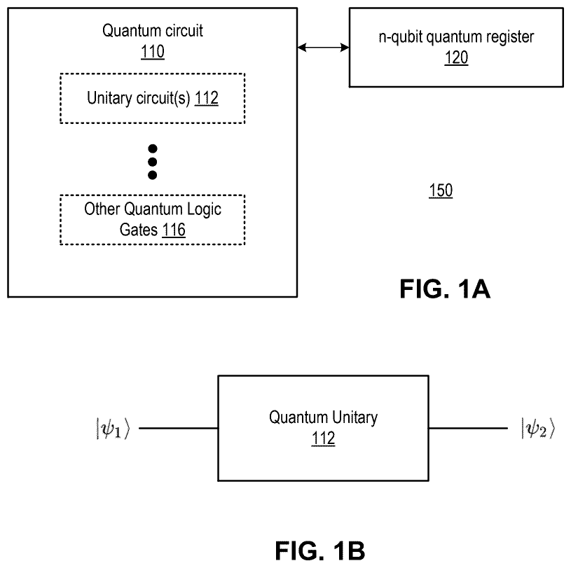

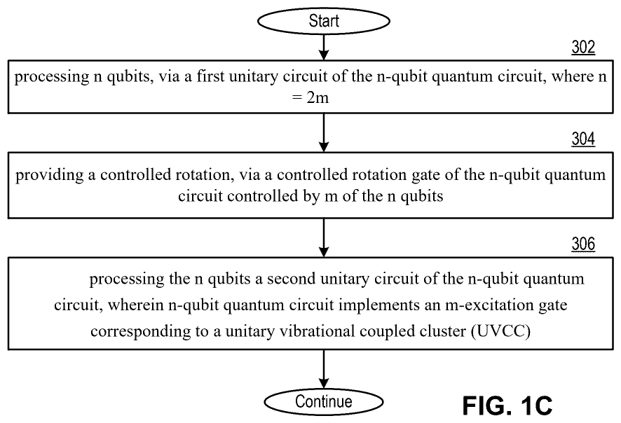

FIG. 1A is a block diagram of an example of a quantum computing architecture. In particular, a quantum circuit 110 is presented that includes one or more unitary circuits 112, and/or one or more other quantum logic gates 116 that operate on n qubits of a quantum register 120. The unitary circuits, which may also be referred to as “unitaries” or “unitary gates” perform a quantum operation on an input quantum state either with, or without, the aid of additional ancillas. It should be noted that a unitary circuit can itself contain other unitary circuits as components/building blocks. Unitary circuits can play a fundamental role in quantum algorithms by providing a way to manipulate quantum states and perform computations that are not possible with classical computers.

In various examples, the action of a unitary circuit on a specific quantum state can be found by multiplying an input vector, which represents the input qubit state, by a matrix transformation (or simply “matrix”) representing the particular function being implemented. The result is a new quantum vector state. Most generally, the input vector state can be represented most by:

$$\vert {Ψ}_{1} 〉$$

And the output vector state can be represented most by:

$$\vert {ψ}_{2} 〉$$

as shown in FIG. 1B.

One can note that quantum simulations based on variational approaches such as the variational quantum eigensolver (VQE) are used in applications such as quantum chemistry, quantum simulations and optimization. One choice for quantum chemistry calculations is a class of methods based on unitary coupled cluster (UCC) theory. These methodologies involve the use of an exponential ansatz to represent the wave function, incorporating both single and double excitations (and potentially higher-order excitations as well). The use of unitary transformations preserves the inner product in Hilbert space. In the context of UCC, this means that the methods can be constructed to ensure that they maintain the quantum mechanical properties of the system.

More specifically, a unitary vibrational coupled cluster (UVCC) presents a theoretical framework used in quantum chemistry to describe the electronic structure of molecular systems that exhibit vibrational motion. This approach extends traditional coupled cluster methods, which are primarily focused on electronic correlations, to also account for the vibrational modes of molecules. UVCCs are particularly useful in simulating different types of molecular systems, including those with strong electron-phonon interactions and where both electronic and vibrational motions play significant roles, such as in spectroscopy, reaction dynamics, and non-adiabatic processes. Overall, unitary vibrational coupled clusters represent a sophisticated approach to understanding the intricate interplay between electronic and vibrational dynamics in molecular systems, enhancing the ability to predict and analyze chemical behavior and properties.

The methods and circuits that follow improve the technology of UCCs and UVCCs by providing a more efficient method for implementing a cluster operator for molecular vibrations calculations. In various examples, the quantum circuit 110 is a n-qubit quantum circuit that includes:
a first unitary circuit operating on n qubits, where n=2 m;
a rotation gate controlled by m of the n qubits;
a second unitary circuit operating on the n qubits;
wherein n-qubit quantum circuit implements an m-excitation gate corresponding to a unitary vibrational coupled-cluster (UVCC).

In addition or in the alternative to any of the foregoing, the rotation gate is controlled by alternating qubits of the n qubits.

In addition or in the alternative to any of the foregoing, the rotation gate implements a single m-controlled Y-rotation.

In addition or in the alternative to any of the foregoing, the first unitary circuit implements a first unitary operator and the second unitary circuit a second unitary operator and where the second unitary operator is an inverse of the first unitary operator.

In addition or in the alternative to any of the foregoing, the rotation gate implements a single m-controlled Y-rotation operator and wherein the quantum circuit implements a product of the first unitary operator, the m-controlled Y-rotation operator and the second unitary operator on the 2 m qubits.

In addition or in the alternative to any of the foregoing, the m-excitation gate is implemented in accordance with an m-controlled rotation.

In addition or in the alternative to any of the foregoing, m is greater than zero.

In addition or in the alternative to any of the foregoing, the first unitary circuit, the second unitary circuit and the rotation gate are collectively implemented with less than 8 m−6 CNOT gates.

In addition or in the alternative to any of the foregoing, the n qubits are mapped to bosonic states of the UVCC.

In addition or in the alternative to any of the foregoing, m-excitation gate prepares a UVCC ansatz.

FIG. 1C is a flow diagram of an example method. In particular, a method is presented for use in a quantum circuit, such as quantum circuit 110. Step 302 includes processing n qubits, via a first unitary circuit of the n-qubit quantum circuit, where n=2 m. Step 304 includes providing a controlled rotation, via a rotation gate of the n-qubit quantum circuit controlled by m of the n qubits; and processing the n qubits a second unitary circuit of the n-qubit quantum circuit, wherein n-qubit quantum circuit implements an m-excitation gate corresponding to a unitary vibrational coupled cluster (UVCC).

In addition or in the alternative to any of the foregoing, the rotation gate is controlled by alternating qubits of the n qubits.

In addition or in the alternative to any of the foregoing, the rotation gate implements a single m-controlled Y-rotation.

In addition or in the alternative to any of the foregoing, the first unitary circuit implements a first unitary operator and the second unitary circuit a second unitary operator and where the second unitary operator is an inverse of the first unitary operator.

In addition or in the alternative to any of the foregoing, the rotation gate implements a single m-controlled Y-rotation operator and wherein the quantum circuit implements a product of the first unitary operator, the m-controlled Y-rotation operator and the second unitary operator on the 2 m qubits.

In addition or in the alternative to any of the foregoing, the m-excitation gate is implemented in accordance with an m-controlled rotation.

In addition or in the alternative to any of the foregoing, m is greater than zero.

In addition or in the alternative to any of the foregoing, the first unitary circuit, the second unitary circuit and the rotation gate are collectively implemented with less than 8 m−6 CNOT gates.

In addition or in the alternative to any of the foregoing, the n qubits are mapped to bosonic states of the UVCC.

In addition or in the alternative to any of the foregoing, m-excitation gate prepares a UVCC ansatz.

The examples discussed above can further improve the efficiency of ansatz preparation. Furthermore, the use of a direct mapping of bosonic states to qubits simplifies the circuitry. In addition or in the alternative, various examples provide one or more features discussed below:
An implementation an m-excitation gate used in unitary vibrational coupled cluster (UVCC) ansatz preparation.
Utilizing a direct mapping to qubit space, with only a small subspace of the Hilbert space that describes physical states. This allows for implementation of the m-excitation gate with a m-controlled rotation, compared with other methodologies that require a (2 m−1)-controlled rotation.
A methodology requires merely 8 m−6 CNOTs and an implementation of m-controlled rotation.
Circuits requiring a lower number of CNOT gates for m>2 for two choices of multi-controlled gate decomposition:
   Assuming exponential decomposition of multi-controlled rotation, a solution uses 25 CNOTs for m=3 and 42 CNOTs for m=4, compared with other techniques that require 41 CNOTS and 142 CNOTs respectively,
   For linear decompositions, a methodology is presented that offers a better scaling with m, giving for example a 28% advantage for a decomposition.

Consider further the various functions and features described in the examples that follow.

In vibrational calculations the nuclear dynamics are described in terms of a fixed number of modes M corresponding to a set of coordinates {Qᵢ}. For simplicity, one can consider the basis set to be the harmonic oscillator eigenstates, since it allows for easy mapping to qubits. However, the following methodologies can be generalized to other basis sets. In direct mapping, the first d eigenstates of a single harmonic oscillator |n [symbol] are encoded as

$$\vert n 〉 = {⊗}_{j = 0}^{n - 1} \vert 0 {〉}_{j} \vert 1 {〉}_{n} {⊗}_{j = n + 1}^{d - 1} \vert 0 {〉}_{j} \qquad ( 1 )$$

Despite the inefficiency in terms of number of qubits, this approach allows for more shallow circuits. It can be shown that the redundancy in qubit number can be used to improve the state preparation circuit even further.

A unitary vibrational coupled cluster ansatz can be obtained by applying cluster operator to initial state

$$\vert Ψ ( θ ) 〉 = exp ( T - {T}^{†} ) \vert {Ψ}_{0} 〉 \qquad ( 2 )$$

where θ denotes the set of parameters and T is a sum of excitation operators:

$$T = {T}_{1} + {T}_{2} + ... \qquad ( 3 )$$

$$and$$

$${T}_{1} = {\sum }_{i = 1}^{M} {\sum }_{{n}_{i} , {m}_{j} = 0}^{d - 1} {θ}_{{n}_{i} , {m}_{i}} \vert {n}_{i} \text{〉 〈} {m}_{j} \vert \qquad ( 4 )$$

$${T}_{2} = {\sum }_{i < j}^{M} {\sum }_{{n}_{i} , {m}_{i} , {k}_{j} , {l}_{j} = 0}^{d - 1} {θ}_{{n}_{j} , {m}_{j} , {k}_{j} , {l}_{j}} \vert {n}_{i} \text{〉 〈} {m}_{i} \vert ⊗ \vert {k}_{j} \text{〉 〈} {l}_{j} \vert \qquad ( 5 )$$

After trotterization and applying direct mapping the cluster operator from equation (2) can be expressed as a product of m-excitation unitaries acting on the appropriate qubits. These unitaries, up to the reordering of qubits, all have the following form

$${U}_{m} ( θ ) = exp θ ( \vert {e}_{m} \text{〉 〈} {g}_{m} \vert - \vert {g}_{m} \text{〉 〈} {e}_{m} \vert ) \qquad ( 6 )$$

with

$$\begin{matrix}\vert {g}_{m} 〉 = {⊗}_{i = 0}^{m - 1} \vert 01 {〉}_{i} & \vert {e}_{m} 〉 = {⊗}_{i = 0}^{m - 1} \vert 10 {〉}_{i}\end{matrix} \qquad ( 7 )$$

In some approaches, these gates are expressed in terms of Pauli operators using the relation

$$\vert 0 〉 〈 1 \vert = \frac{1}{2} ( X + i Y )$$

Another trotterization is then applied, leading to 2^{(2m-1)} gates generated by a single Pauli operator, which can be decomposed using 2^{(2m-1)} CNOT gates. Therefore, these prior methods requires 4^{m}(2 m−1) 2-qubit gates to implement m-excitation unitary.

More efficient approaches can be based on the fact that the unitaries defined in equation (6) perform a 2-dimensional rotation in the space spanned by |gₘ [symbol] and |eₘ [symbol] , while leaving the other states unchanged:

$${U}_{m} ( θ ) \vert {g}_{m} 〉 = cos θ \vert {g}_{m} 〉 + sin θ \vert {e}_{m} 〉 \qquad ( 8 )$$

$${U}_{m} ( θ ) \vert {e}_{m} 〉 = - sin θ \vert {g}_{m} 〉 + cos θ \vert {e}_{m} 〉 \qquad ( 9 )$$

$${U}_{m} ( θ ) \vert l 〉 = \vert l 〉 \qquad ( 10 )$$

for [symbol] = [symbol] =0. The general strategy is now to express Uₘ(θ) as

$${U}_{m} ( θ ) = {𝒰}_{m}^{†} R Y ( θ , \{ {q}_{1} ... {q}_{2 m - 1} \} , {q}_{0} ) {𝒰}_{m} \qquad ( 11 )$$

where [symbol] transforms states [symbol] so that they only differ in the first qubit and RY (θ, {q₁ . . . q₂ₘ₋₁}, q₀) is Y-rotation on q₀ controlled by {q₁ . . . q₂ₘ₋₁}. This notation for multi-controlled rotations has been proposed for a prior implementation of a double excitation unitary, where it was shown that the number of 2-qubit gates can be reduced to 13 (from 48 in a standard textbook approach). In these solutions [symbol] gate consisted of 3 CNOT gates. Generalizing these methodologies for higher excitation, [symbol] would still require (2 m−1) CNOT gates. This leads to the cost of 2(2 m−1) CNOT's plus the implementation of the (2 m−1)-controlled Y-rotation.

In contrast to prior methods, various examples disclosed herein present a case of molecular vibration calculation with direct mapping, implementing m-excitation unitary with 8 m-6 CNOT's and a single m-controlled Y-rotation. These examples use the fact that with direct mapping, works on a small subspace of the full Hilbert space. Therefore, it is sufficient for a decomposed gate to work correctly only in this subspace.

In various examples, a methodology is employed that has a similar structure to equation (11), but with Y-rotation controlled only on every second qubit:

$${U}_{m} ( θ ) = {𝒰}_{m}^{†} R Y ( θ , \{ {q}_{1} , {q}_{3} ... , {q}_{2 m - 1} \} , {q}_{0} ) {𝒰}_{m} \qquad ( 12 )$$

Here, the [symbol] gate is defined as follows

$${𝒰}_{m} = C X ( {q}_{0} , {q}_{1} ) {\prod }_{j = 1}^{m - 1} {𝒮}_{j} \qquad ( 13 )$$

with Sⱼ being a 3-qubit gate applied to the qubits of j-th mode and the first qubit:

$${𝒮}_{j} = C X ( {q}_{2 j + 1} , {q}_{2 j} ) R T O F ( \{ {q}_{0} , {q}_{2 j} \} , {q}_{2 j + 1} ) \qquad ( 14 )$$

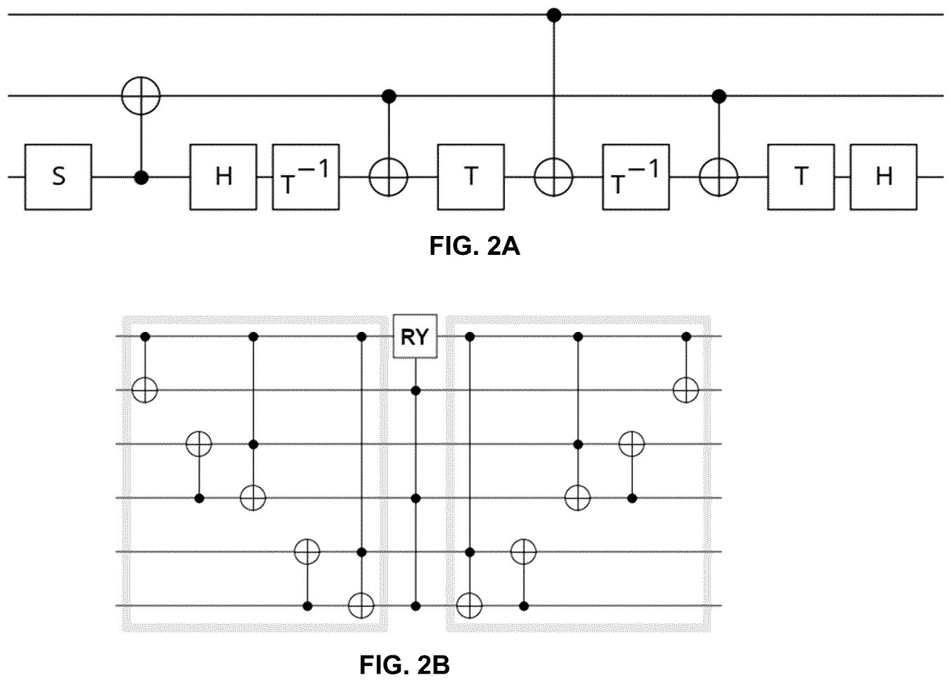

The RTOF gate is a relative phase Toffoli, which can be implemented with 3CNOT gates. A circuit implementing Sⱼ is shown in FIG. 2A which presents a decomposition of a Sⱼ gate into single qubit gate and CNOTs

The Sⱼ gate transforms the states of interest in the following way:

$$\begin{matrix}{𝒮}_{j} \vert 00 {〉}_{j} \vert 0 {〉}_{0} = \vert 00 {〉}_{j} \vert 0 {〉}_{0} & {𝒮}_{j} \vert 00 {〉}_{j} \vert 1 {〉}_{0} = \vert 00 {〉}_{j} \vert 1 {〉}_{j}\end{matrix} \qquad ( 15 )$$

$$\begin{matrix}{𝒮}_{j} \vert 01 {〉}_{j} \vert 0 {〉}_{0} = \vert 01 {〉}_{j} \vert 0 {〉}_{0} & {𝒮}_{j} \vert 01 {〉}_{j} \vert 1 {〉}_{0} = - i \vert 11 {〉}_{j} \vert 1 {〉}_{0}\end{matrix} \qquad ( 16 )$$

$$\begin{matrix}{𝒮}_{j} \vert 10 {〉}_{j} \vert 0 {〉}_{0} = - i \vert 11 {〉}_{j} \vert \vert 0 {〉}_{0} & {𝒮}_{j} \vert 10 {〉}_{j} \vert 1 {〉}_{0} = \vert 01 {〉}_{j} \vert 1 {〉}_{0}\end{matrix} \qquad ( 17 )$$

Since we are working with direct mapping, we are not interested in the states |11ⱼ|0 [symbol] ₀, |11 [symbol] ⱼ|1 [symbol] ₀. From these equations one can see that after applying [symbol] the second qubit of each mode will be in state |1 [symbol] only if the initial state was |gₘ [symbol] or |eₘ [symbol] . These states transform as follows:

$${𝒰}_{m} \vert {g}_{m} 〉 = - i {⊗}_{j = 1}^{m - 1} \vert 11 {〉}_{j} \vert 11 {〉}_{0} \qquad ( 18 )$$

$${𝒰}_{m} \vert {e}_{m} 〉 = - i {⊗}_{j = 1}^{m - 1} \vert 11 {〉}_{j} \vert 10 {〉}_{0} \qquad ( 19 )$$

And, they differ only on the first qubit. By applying the controlled rotation and the inverse of [symbol] equations (8) and (9) can be obtained. FIG. 2B an example of a described circuit for m=3 where The qubits are numbered from 0 at the top to 5 at the bottom. The first red box corresponds to

$${𝒰}_{m}^{†}$$

and the second red box corresponds to [symbol] .

As explained before, the standard methods of implementing the m-excitation unitary requires 4^{m}(2 m−1) CNOT gates while the prior best approach requires 2(2 m−1) CNOT's and a (2 m−1)-controlled rotation. The examples presented herein however have a cost of (8 m−6) CNOT's plus a m-controlled rotation. The exact comparison will depend on the choice of method for decomposition of multi-controlled rotation—yet still yields a significant improvement in efficiency.

Furthermore, when ancilla qubits are allowed, linear decomposition in terms of m is possible. Instead of focusing on a particular approach, consider a class of methods that implements C^{m}X by (An−B) Toffoli gates, with A, and B being integer coefficients. A n-controlled rotation can be implemented with two C^{m-1}X gates and two single-controlled rotations. Since a Toffoli gate can be realized with 6 2-qubit gates, the expression for the number of CNOTs is:

(12A+8)m−12A−12B−2.

The methodologies described herein again offer an advantage in scaling over prior techniques that require (24A+4)m−24A−12B+2 CNOTs. This also holds true if we assume that a decomposition of C^{m}X′ can be done with relative phase Toffili gates. Additionally, if a method requires a number of ancilla qubits linear in n, the cost of additional qubits would also be reduced by half. Even considering the case where A=2, B=3, the methodologies disclosed herein offer around a 28% advantage in scaling.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. An n-qubit quantum circuit comprising:
a first unitary circuit operating on n qubits, where n=2 m;
a rotation gate controlled by m of the n qubits; and
a second unitary circuit operating on the n qubits;
wherein n-qubit quantum circuit implements an m-excitation gate corresponding to a unitary vibrational coupled-cluster (UVCC).

2. The quantum circuit of claim 1, wherein the rotation gate is controlled by alternating qubits of the n qubits.

3. The quantum circuit of claim 1, wherein the rotation gate implements a single m-controlled Y-rotation.

4. The quantum circuit of claim 1, wherein the first unitary circuit implements a first unitary operator and the second unitary circuit a second unitary operator and where the second unitary operator is an inverse of the first unitary operator.

5. The quantum circuit of claim 4, wherein the rotation gate implements a single m-controlled Y-rotation operator and wherein the quantum circuit implements a product of the first unitary operator, the m-controlled Y-rotation operator and the second unitary operator on the 2 m qubits.

6. The quantum circuit of claim 1, wherein the m-excitation gate is implemented in accordance with an m-controlled rotation.

7. The quantum circuit of claim 1, wherein m is greater than zero.

8. The quantum circuit of claim 7, wherein the first unitary circuit, the second unitary circuit and the rotation gate are collectively implemented with less than 8 m−6 CNOT gates.

9. The quantum circuit of claim 1, wherein the n qubits are mapped to bosonic states of the UVCC.

10. The quantum circuit of claim 1, wherein m-excitation gate prepares a UVCC ansatz.

11. A method for use with an n-qubit quantum circuit, the method comprising:
processing n qubits, via a first unitary circuit of the n-qubit quantum circuit, where n=2 m;
providing a controlled rotation, via a rotation gate of the n-qubit quantum circuit controlled by m of the n qubits; and
processing the n qubits a second unitary circuit of the n-qubit quantum circuit, wherein n-qubit quantum circuit implements an m-excitation gate corresponding to a unitary vibrational coupled cluster (UVCC).

12. The method of claim 11, wherein the rotation gate is controlled by alternating qubits of the n qubits.

13. The method of claim 11, wherein the rotation gate implements a single m-controlled Y-rotation.

14. The method of claim 11, wherein the first unitary circuit implements a first unitary operator and the second unitary circuit a second unitary operator and where the second unitary operator is an inverse of the first unitary operator.

15. The method of claim 14, wherein the rotation gate implements a single m-controlled Y-rotation operator and wherein the quantum circuit implements a product of the first unitary operator, the m-controlled Y-rotation operator and the second unitary operator on the 2 m qubits.

16. The method of claim 11, wherein the m-excitation gate is implemented in accordance with an m-controlled rotation.

17. The method of claim 11, wherein m is greater than zero.

18. The method of claim 17, wherein the first unitary circuit, the second unitary circuit and the rotation gate are collectively implemented with less than 8 m−6 CNOT gates.

19. The method of claim 11, wherein the n qubits are mapped to bosonic states of the UVCC.

20. The method of claim 11, wherein m-excitation gate prepares a UVCC ansatz.
